(19) United States
(12) Patent Application Publication
(10) Pub. No.: US 2024/0365733 A1
(43) Pub. Date: Nov. 7, 2024

(54) CLIMATE CONTROL CHAMBER

(71) Applicant: Jacques Mauritz VAN BUUREN, Southlake, TX (US)

(72) Inventor: Jacques Mauritz VAN BUUREN, Southlake, TX (US)

(21) Appl. No.: 18/690,395

(22) PCT Filed: Sep. 12, 2022
(86) PCT No.: PCT/IB2022/058558

§ 371 Date: Mar. 8, 2024

Related U.S. Application Data
(60) Provisional application No. 63/242,617, filed on Sep. 10, 2021.

(51) Int. Cl. A01G 31/02; A01G 31/00

(52) U.S. Cl. CPC A01G 31/02; A01G 2031/006

(57) ABSTRACT

The invention relates a growth arrangement which includes an array of compartments for housing a hydroponic planter in each compartment and a plurality of shafts interconnecting the compartments, which shafts housing a fluid delivery and recovery system for conveying fluids to and from the individual compartments. The growth arrangement is capable of being isolated from the environment by means of closures attached to the compartment. Furthermore, a fluid conditioning system is provided, capable of conditioning liquid prior to insertion thereof via the fluid delivery and recovery system. The invention extends to a growth arrangement kit which includes a plurality of prefabricated members, when assembled, to define an array of compartments and a plurality of shafts insertable within the array of compartments, thereby interconnecting the compartments. The shaft capable of housing a fluid delivery and recovery system for conveying fluids to and from the individual compartments.

### FIELD OF THE INVENTION

This invention relates to a climate control chamber. In particular, the invention relates to a growth arrangement and to a modular growth arrangement kit.

### BACKGROUND OF THE INVENTION

Hydroponics is a process of growing plants without a soil based growing medium.

A hydroponic system is often laborious, expensive and time consuming to install. However, once the hydroponics system is operational the yield per square meter is substantially higher, when compared to conventional farming operations. Furthermore, the process can be much better controlled than soil based growing systems.

However, a feasible and profitable hydroponics system is still exposed to various pests and plaques that can impact potential yield.

Having considered existing hydroponics systems, the inventor has identified a need to provide a hydroponic system that is simple to install and that provides protection against pests and plaques and furthermore provides a more energy efficient environment for plants to grow in.

### SUMMARY OF THE INVENTION

According to a first aspect of the invention there is provided a growth arrangement, which includes an array of compartments for housing a hydroponics planter in each compartment; and
a plurality of shafts interconnecting the compartments, the plurality of shafts housing a fluid delivery and recovery system for conveying fluids to and from the individual compartments.

The growth arrangement may include closures to close the compartments, thereby substantially isolating the compartments from the environment.

The array of compartments may include open sides, through which the hydroponic planters may be accessed. The closures may include doors.

In one embodiment, the doors may comprise of gull wing doors hingedly attached to an upper portion of the array of compartments.

The doors may comprise of motorized skylight blinds disposed on each open side, operable to slide in a vertical direction.

The closures may include an actuating mechanism attached to the doors for opening and closing the doors.

The growth arrangement may include a liquid recovery basin positioned below the array of compartments, operable via the fluid delivery and recovery system to recover liquids from the array of compartments.

The growth arrangement may include a fluid conditioning system, operable to condition liquids prior to circulating the liquids via the fluid delivery and recovery system.

In one embodiment, the shafts may extend vertically to connect vertically extending compartments to each other.

The shafts may be subdivided into individual ducts. The growth arrangement may include conduits disposed in the ducts. The ducts may include any one or more of: air supply ducts, liquid supply ducts, liquid retrieval ducts, electrical ducts or ducts for other similar utilities.

The liquid retrieval ducts may be in fluid flow communication with the liquid recovery basin. The liquid supply ducts and the air supply ducts may be in fluid flow communication with the fluid conditioning system.

The conditioning system may include a heating device, a ventilation device, and air conditioning (HVAC) device.

The liquid supply ducts may include at least one outlet into each compartment, connectable to a hydroponics planter. The liquid retrieval ducts may include at least one inlet from each compartment, connectable to a hydroponics planter. The air ducts may include at least one outlet into each compartment.

The at least one outlet may be connectable to a hydroponics planter.

In use, the hydroponics planter may connect to the at least one inlet and outlet, the liquid retrieval ducts, and the liquid supply ducts, respectively, and the liquid recovery basin and the fluid conditioning system may define a closed loop fluid circulation system.

The growth arrangement may include a lighting system disposed within the array of compartments, thereby providing light in each compartment.

The growth arrangement may include heating means for the individual compartments, for providing heat in each compartment.

The growth arrangement may include environmental sensors in each compartment for sensing the environmental parameters in each compartment. The environmental sensors may include temperature sensors, humidity sensors, light sensors, or the like.

According to another aspect of the invention there is provided a modular growth arrangement kit, which includes
a plurality of prefabricated members, shaped and dimensioned, when assembled, to define an array of compartments for housing a hydroponics planter in each compartment; and
a plurality of shafts, shaped and dimensioned to be insertable within the array of compartments, thereby interconnecting the compartments for housing a fluid delivery and recovery system for conveying fluids to and from the individual compartments.

The invention will now be described, by way of example only, with reference to the following figures.

### FIGURE(S)

### In the Figures:

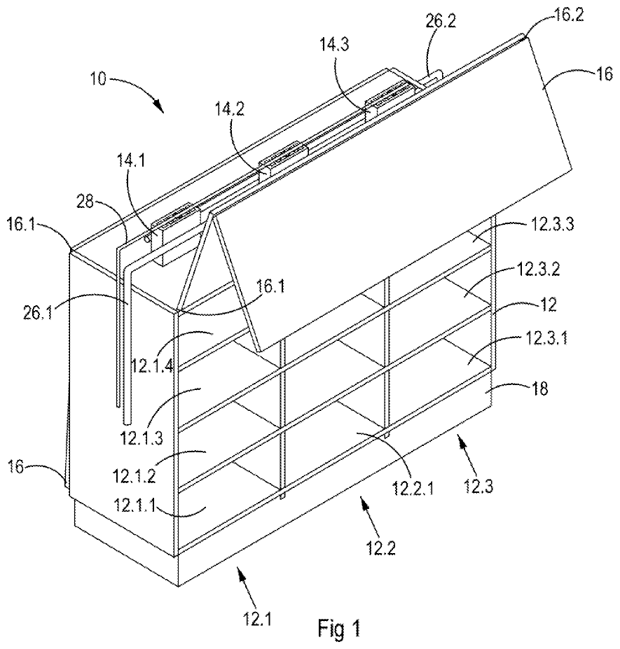

FIG. 1 shows a three-dimensional view of a growth arrangement in accordance with one aspect of the invention;

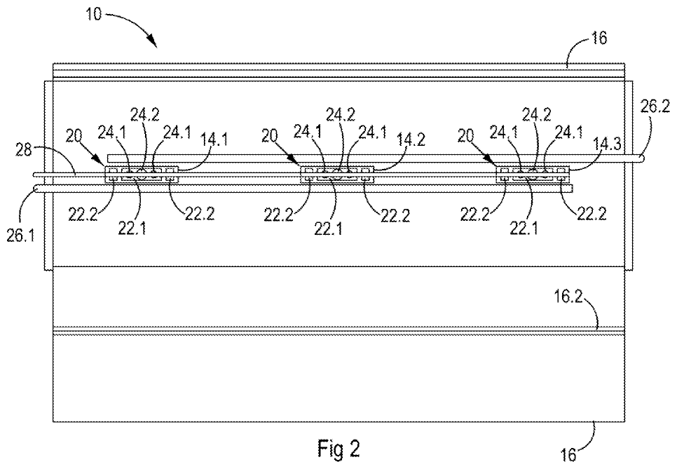

FIG. 2 shows a top view of the growth arrangement as shown in FIG. 1;

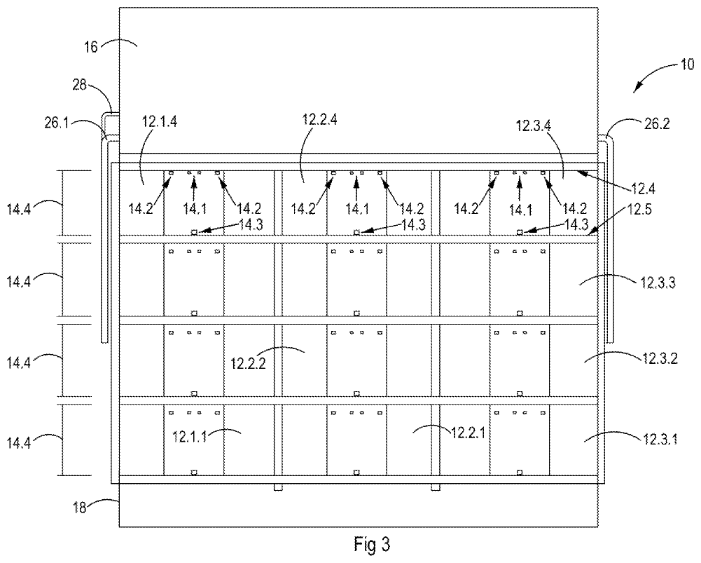

FIG. 3 shows a front view of the growth arrangement as shown in FIG. 1; and

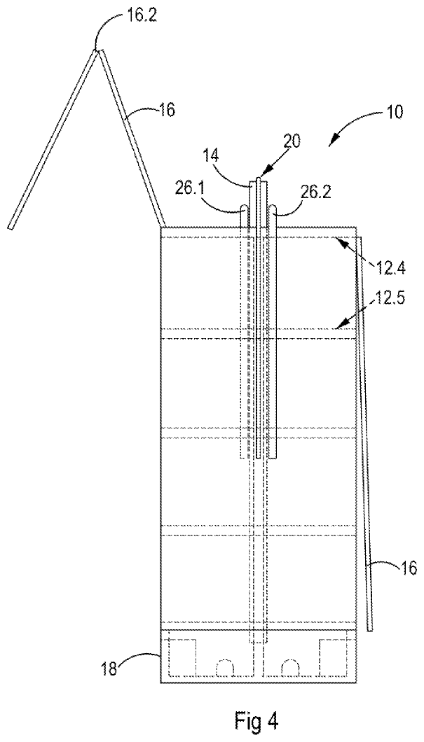

FIG. 4 shows a cross-sectional view of the growth arrangement of FIG. 1.

In the figures, like reference numerals denote like parts of the invention unless otherwise indicated.

### EMBODIMENT OF THE INVENTION

In FIG. 1 reference numeral 10 refers to a growth arrangement which includes an array of compartments (12) for housing a hydroponic planter (not shown) in each compartment (12) and shafts (14) interconnecting the compartments (12).

Each shaft (14) is shaped and dimensioned to house a fluid delivery and recovery system (20), shown in FIG. 2, for conveying fluids to and from the individual compartments (12).

It should be appreciated that, the term fluid for this example refers to any one or more of: nutrient carrying liquids, nutrient depleted liquids, gasses, water and air. Furthermore, each hydroponic planter is shaped and dimensioned to house a plurality plants therein (not shown), whereby each plant's rooting system is positioned within the hydroponic planter and a stem portion extends from within the hydroponic planter outwards.

In this example, the array of compartments (12) includes a two-dimensional arrangement, comprising of a plurality of adjacent compartments arranged vertically in columns (12.1, 12.2, 12.3) and horizontally in rows (12.1.1-12.1.4, 12.2.1-12.2.4, 12.3.1-12.3.4), resulting in a cuboid shape. Furthermore, the two-dimensional arrangement (12) includes one opposing open side through which the hydroponic planters are accessed. Due to the modularity of the growth arrangement's (10) design, the number of rows and columns may be selected based on requirements and available space.

The shafts (14.1, 14.2, 14.3) extend vertically through the vertical columns (12.1, 12.2, 12.3), respectively, to connect the compartments (12.1.1-12.1.4, 12.2.1-12.2.4, 12.3.1-12.3.4) to each other.

Furthermore, the growth arrangement (10) includes closures (16) operable to close the opposing open sides thereof, thereby substantially isolating the compartments (12) from the environment, resulting in hermetically concealed growing environment.

In one embodiment of the invention, not shown, the closures (16) include motorized skylight blinds disposed on each open side, operable to slide in a vertical direction, in order to open and close the open sides.

In a preferred embodiment, shown in FIG. 1, the closures (16) include gull wing doors hingedly attached to an upper portion of the array of compartments (12), by means of a hinge (16.1). Furthermore, each gull wing door (16) includes an additional hinge (16.2), thereby dividing each door (16) into two segments, resulting in a foldable door configuration.

In use, the foldable door configuration allows for a better utilization of space, as the opening of the doors (16) require less clearance for the doors to be moved between an open and closed configuration. In FIG. 1, only one of the gull wing doors (16) is shown in an open configuration.

The growth arrangement (10) includes a liquid recovery basin (18) (see FIG. 3) positioned below the array of compartments (12) operable via the fluid delivery and recovery system (20) to recover liquids from the array of compartments (12).

Once recovered, the liquids are conditioned by means of a fluid conditioning system (not shown) prior to re-introducing them to the growth arrangement (10) via the fluid deliver and recovery system (20).

As can be seen in FIG. 2, each shaft (14) is subdivided into individual ducts (22), which comprise of an air supply duct (22.1) and air suction ducts (22.2). Furthermore, the air supply duct (22.1) includes conduits (24) disposed therein, which conduits (24.1, 24.2) provide for a liquid supply conduit and a liquid retrieval conduit, respectively.

The liquid retrieval conduits (24.2) are in fluid flow communication with both the compartments (12) and the liquid recover basin (18) on opposed sides of the shafts (14.1-14.3). In use, liquids are received from the hydroponic planter via the liquid retrieval conduit (24.2) and thereafter deposited within the liquid recovery basin (18). Furthermore, the liquid supply conduits (24.1) and the air ducts (22.1, 22.2) are connected to both the compartments (12) and to the fluid conditioning system on opposed sides of the shafts (14.1-14.3).

The fluid conditioning system includes an HVAC device (not shown), connected to the growth arrangement (10) by means of a distribution system (26.1, 26.2), in the form of pipes. In use, the HVAC device is in flow communication with each air suction duct (22.2) and with each air supply duct (22.1), thereby allowing for the regulation of air supply to and from each compartment (12). In use, cool air is provided via the HVAC device to supply conditioned air to the plant's roots system, and hot air produced within the compartments (12) is extracted therefrom via the HVAC device.

Furthermore, the fluid conditioning system includes a liquid purification device (not shown) and a nutrient supply device (not shown), connected to the liquid recovery basin (18) by means of a supply line (28), allowing for the recovered liquids deposited with the liquid recovery basin (18) to be reconditioned and re-circulated into the growth arrangement (10) via the supply line (28).

In FIG. 3 it shows that, each shaft (14) includes a plurality of outlets (14.1) and inlets (14.2, 14.3), arranged on an outer periphery thereof and grouped into vertically arranged segments (14.4) onto each shaft (14), allowing for a growing environment of each individual compartment (12) to be controlled separately.

In this example, the air supply duct (22.1) and/or the liquid supply conduits (24.1) are connected to the outlets (14.1), the air suction ducts (22.2) are connected to the inlets (14.2) and the liquid retrieval conduit (24.2) is connected to the inlet (14.3). Furthermore, each outlet (14.1) and inlet (14.3, 14.3) are connectable to at least one hydroponic planter disposed within each compartment (12). Therefore, in use, the hydroponic planter, the connections to the outlets (14.1) and inlets (14.2 14.3), the liquid retrieval conduit (24.2), the liquid supply conduits (24.1), the liquid recovery basin (18) and fluid conditioning system define a closed loop fluid circulation system.

It should be appreciated that, air supplied via the HVAC device through the air supply ducts (20.1), results in a positive pressure within each hydroponic planter connected thereto.

The growth arrangement (10) includes a lighting system (not shown) of which lights are disposed on an upper surface (12.4) and bottom surface (12.5) of each compartment (12), and the corresponding electrical wiring thereof is fitted within the air suction ducts (22.2), thereby providing light to each compartment (12).

The growth arrangement (10) includes environmental sensors (not shown) disposed within each compartment (12) for sensing environmental parameters in each compartment (12). In use, the environmental sensors are indictive to whether or not an adjustment needs to be made to the HVAC device and/or the lighting system to allow for optimal growing conditions of the plants grown within each compartment (12).

The inventor believes that the invention provides a novel growth arrangement and a modular growth arrangement kit, which in use provides for a sterile and controllable growing environment for plants, simple to install and resistive towards pests and plaques

1-28. (canceled)

29. A growth arrangement, which includes
an array of compartments for housing a hydroponics planter in each compartment, the array of compartments having open sides through which the hydroponic planters are accessible;
a plurality of shafts interconnecting the compartments, the plurality of shafts housing a fluid delivery and recovery system for conveying fluids to and from the individual compartments; and
closures to close the open sides of the compartments, thereby isolating the compartments from the environment.

30. The growth arrangement as claimed in claim 29, in which the closures are in the form of doors hingedly attached to an upper portion of the array of compartments.

31. The growth arrangement as claimed in claim 30, in which the doors comprise of motorized skylight blinds disposed on each open side, operable to slide in a vertical direction.

32. The growth arrangement as claimed in claim 29, in which the closures include an actuating mechanism attached to the closures for opening and closing of the closures.

33. The growth arrangement as claimed in claim 29, which includes a liquid recovery basin positioned below the array of compartments, operable via the fluid delivery and recovery system to recover liquids from the array of compartments.

34. The growth arrangement as claimed in claim 33, which includes a fluid conditioning system, operable to condition liquids prior to circulating the liquids via the fluid delivery and recovery system.

35. The growth arrangement as claimed in claim 34, in which the shafts extend vertically to connect vertically extending compartments to each other.

36. The growth arrangement as claimed in claim 35, in which the shafts are subdivided into individual ducts, in the form of any one or more of: air supply ducts, liquid supply ducts, liquid retrieval ducts and electrical ducts.

37. The growth arrangement as claimed in claim 36, in which the liquid retrieval ducts are in fluid flow communication with the liquid recovery basin.

38. The growth arrangement as claimed in claim 36, in which the liquid supply ducts and the air supply ducts are in fluid flow communication with the fluid conditioning system.

39. The growth arrangement as claimed in claim 38, in which the fluid conditioning system includes any one or more of the following: a heating device, a ventilation device, and air conditioning (HVAC) device.

40. The growth arrangement as claimed in 36, in which the liquid supply ducts include at least one outlet into each compartment, connectable to a hydroponics planter.

41. The growth arrangement as claimed in claim 36, in which the liquid retrieval ducts include at least one inlet from each compartment, connectable to a hydroponics planter.

42. The growth arrangement as claimed in claim 36, in which the air supply ducts include at least one outlet into each compartment.

43. The growth arrangement as claimed in claim 42, in which the at least one outlet is connectable to a hydroponics planter.

44. The growth arrangement as claimed in 43, in which the hydroponics planter, connects to at least one inlet and outlet of the liquid retrieval ducts and the liquid supply ducts, respectively, and in which the liquid recovery basin and the fluid conditioning system define a closed loop fluid circulation system.

45. The growth arrangement as claimed in claim 29, which includes any one or more of:
a lighting system disposed within the array of compartments, thereby providing light in each compartment;
heating means for the individual compartments, for providing heat in each compartment;
environmental sensors, in the form of any one or more of: temperature sensors, humidity sensors and light sensors, in each compartment for sensing environmental parameters in each compartment.

46. A modular growth arrangement kit, which includes
a plurality of prefabricated members, shaped and dimensioned, when assembled, to define an array of compartments for housing a hydroponics planter in each compartment; and
a plurality of shafts, shaped and dimensioned to be insertable within the array of compartments, thereby interconnecting the compartments for housing a fluid delivery and recovery system for conveying fluids to and from the individual compartments.
